(19) United States
(12) Patent Application Publication
(10) Pub. No.: US 2010/0062272 A1
(43) Pub. Date: Mar. 11, 2010

(54) TRANSPARENT PART

(75) Inventors: Roland Wursche, Duelmen (DE); Karl Kuhmann, Duelmen (DE); Beatrice Kueting, Marl (DE); Patrick Kreidler, Recklinghausen (DE); Kirsten Luetzeler, Muenster (DE); Klaus Huelsmann, Haltern am See (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/515,543

(22) PCT Filed: Dec. 4, 2007
(86) PCT No.: PCT/EP07/63261

§ 371 Date: May 20, 2009

(30) Foreign Application Priority Data
Dec. 13, 2006 (DE) 10-2006-058-681.6

(51) Int. Cl. B32B 27/34; B32B 27/08

(52) U.S. Cl. 428/473.5; 428/474.4; 428/475.2; 428/476.9

(57) ABSTRACT

A transparent component, which comprises the following subcomponents:
I. an outer layer composed of a polyamide moulding composition, which comprises the following constituents:
   a) from 50 to 100 parts by weight of polyamide, which can be prepared from the following monomers:
      α) from 70 to 100 mol % of diamine, selected from m-xylylenediamine, p-xylylenediamine and mixtures thereof,
      β) from 0 to 30 mol % of other diamines having from 6 to 14 carbon atoms,
      where the mol % data here are based on the entirety of diamine, and also
      γ) from 70 to 100 mol % of aliphatic dicarboxylic acids having from 10 to 18 carbon atoms and
      δ) from 0 to 30 mol % of other dicarboxylic acids having from 6 to 9 carbon atoms,
      where the mol % data here are based on the entirety of dicarboxylic acid;
   b) from 0 to 50 parts by weight of another polyamide,
   where the parts by weight of a) and b) give a total of 100,
II. a substrate composed of a moulding composition based on a substantially amorphous polymer,
where
a) the outer layer, any adhesion-promoter layer present, and also any further layers present comprise no particulate additives which discernibly reduce transparency and
b) the substrate has, within the visible spectrum from 380 to 800 nm, a maximum of at least 30% in the transmittance curve, at a layer thickness of 1 mm,
is scratch-resistant and chemicals-resistant and suitable for optical applications.

The present invention relates to a transparent component which comprises an external layer composed of a polyamide moulding composition, which derives from xylylenediamine and from a higher dicarboxylic acid.

Transparent components, such as lenses, displays, panels, inspection glasses, etc. are often produced from amorphous materials, such as polycarbonate, PMMA or transparent polyamides. These have good transparency, but exhibit poor chemicals resistance and low scratch resistance. For applications where these materials can possibly come into contact with chemicals or solvents, low chemicals resistance is disadvantageous, since phenomena such as haze or cracking can occur. Poor scratch resistance shortens the lifetime of the transparent articles, since scratching likewise leads to undesired haze effects.

In principle, an outer layer composed of a semicrystalline polyamide can be used in order to achieve improved resistance of transparent articles with respect to chemicals. By way of example, EP 0 696 501 A2 says that this shortcoming can be eliminated by using polyamide for a coating which adheres well to polyalkyl (meth)acrylate mouldings, and an adhesion promoter has to be used here. DE 197 02 088 A1 describes the use of this idea for polyarylate mouldings. WO 2005/123384, WO 2006/072496, WO 2006/087250, WO 2006/008357 and WO 2006/008358 give further prior art; here, a film which comprises a layer composed of a polyamide moulding composition is bonded to a substrate, e.g. via in-mould coating. The specifications JP60155239A, JP2003118055A, EP 1 302 309 A, EP 0 522 240 A, EP 0 694 377 A, EP 0 734 833 A, WO 9212008 A and EP 0 568 988 A are also worthy of mention by way of example. However, this prior art does not supply a solution to the problem of combining high chemicals resistance with high scratch resistance.

The object of the invention consists in providing a transparent component whose surface features high scratch resistance, and abrasion resistance and high chemicals resistance.

This object has been achieved via a transparent component, which comprises the following subcomponents:
I. an outer layer composed of a polyamide moulding composition, which comprises the following constituents:
   a) from 50 to 100 parts by weight, preferably from 60 to 98 parts by weight, particularly preferably from 70 to 95 parts by weight and with particular preference from 75 to 90 parts by weight, of polyamide, which can be prepared from the following monomers:
      α) from 70 to 100 mol %, preferably from 75 to 99 mol %, particularly preferably from 80 to 98 mol % and with particular preference from 85 to 97 mol %, m- and/or p-xylylenediamine, and
      β) from 0 to 30 mol %, preferably from 1 to 25 mol %, particularly preferably from 2 to 20 mol % and with particular preference from 3 to 15 mol %, of other diamines having from 6 to 14 carbon atoms,
      where the mol % data here are based on the entirety of diamine, and also
      γ) from 70 to 100 mol %, preferably from 75 to 99 mol %, particularly preferably from 80 to 98 mol % and with particular preference from 85 to 97 mol %, of aliphatic dicarboxylic acids having from 10 to 18 carbon atoms and
      δ) from 0 to 30 mol %, preferably from 1 to 25 mol %, particularly preferably from 2 to 20 mol % and with particular preference from 3 to 15 mol %, of other dicarboxylic acids having from 6 to 9 carbon atoms,
      where the mol % data here are based on the entirety of dicarboxylic acid;
   b) from 0 to 50 parts by weight, preferably from 2 to 40 parts by weight, particularly preferably from 5 to 30 parts by weight and with particular preference from 10 to 25 parts by weight, of another polyamide, preferably of a polyamide whose average number of carbon atoms in the monomer units is at least 8,
   where the parts by weight of a) and b) give a total of 100,
II. a substrate composed of a moulding composition based on a substantially amorphous polymer, where
a) the outer layer, any adhesion-promoter layer present, and also any further layers present comprise no particulate additives which discernibly reduce transparency and
b) the substrate has, within the visible spectrum from 380 to 800 nm, a maximum of at least 30% and preferably at least 35%, 40%, 45%, 50%, 55%, 60%, 65%, 70%, 75% or 80%, in the transmittance curve, determined to ASTM D1003 on injection-moulded plaques, at a layer thickness of 1 mm.

Particulate additives here are in particular pigments and metal particles, which are often used for the colouring of a colour layer, but impair or destroy transparency. According to the invention, however, nanoparticles which have substantially no effect on transmittance can be present in the abovementioned layers.

The effective numeric-median particle diameter d₅₀ of these nanoparticles in the moulding composition is less than 150 nm, preferably less than 120 nm, particularly preferably less than 90 nm, with particular preference less than 70 nm and very particularly preferably less than 50 nm or less than 40 nm.

The effective particle diameter should not be confused with the diameter of the primary particles. The latter is not decisive for transparency, but instead the decisive factor is the size of the aggregates or agglomerates actually present in the moulding composition. However, if dispersion is very good the effective particle diameter can fall as far as the diameter of the primary particles, in the limiting case.

The method of determination of effective particle diameters of nanoscale particles or of their aggregates or agglomerates in moulding compositions, and the attendant distribution function, involves preparing a thin layer of the moulding composition. In the case of polyamides, it is advantageous to prepare a low-temperature thin layer at −100° C. A number of transmission electron micrographs is then prepared so as to permit statistical evaluation of a sufficiently large number of particles. This number of particles is, as a function of the circumstances, at least two hundred, but more preferably one thousand particles. The diameter of the particles is measured with the aid of an evaluation programme. The data obtained are converted to a distribution function.

The presence of the particulate additives or of the nanoparticles is not permitted to cause more than 2% impairment of a transparency of the moulding composition when a film whose thickness is 200 μm is tested to ASTM D1003 using light of wavelength 589 nm.

The outer layer, any adhesion-promoter layer present, and also any further layers present preferably comprise not more than 1% by weight of nanoparticles. This amount is entirely sufficient for the purposes of nucleation or of laser inscription.

The polyamide moulding composition according to I. can comprise not more than 20% by weight, not more than 16% by weight, not more than 12% by weight, not more than 8% by weight or not more than 4% by weight of auxiliaries or additives, where the % by weight data are based on the entire polyamide composition.

The other diamine used concomitantly if appropriate in a)β) can by way of example be 1,6-hexamethylenediamine, 1,8-octamethylenediamine, 1,9-nonamethylenediamine, 1,10-decamethylenediamine, 1,12-dodecamethylenediamine, 1,14-tetradecamethylenediamine, 1,4-cyclohexanediamine, 1,3- or 1,4-bis(aminomethyl)hexane, 4,4′-diaminodicyclohexylmethane and/or isophoronediamine.

The dicarboxylic acid of subcomponent a)γ) is preferably linear. Examples of those suitable are 1,10-decanedioic acid, 1,11-undecanedioic acid, 1,12-dodecanedioic acid, 1,13-tridecanedioic acid, 1,14-tetradecanedioic acid, 1,16-hexadecanedioic acid and 1,18-octadecanedioic acid, and preference is given here to 1,12-dodecanedioic acid and 1,14-tetradecanedioic acid. Mixtures can also be used.

The other dicarboxylic acid used concomitantly, if appropriate, in a)δ) is, for example, adipic acid, suberic acid, 1,9-nonanedioic acid, 1,4-cyclohexanedicarboxylic acid, isophthalic acid and/or terephthalic acid.

In one preferred embodiment, the polyamide of a) contains substantially no monomer units which derive from any subcomponent a)β).

In another preferred embodiment, the polyamide of a) contains substantially no monomer units which derive from any subcomponent a)δ).

A further preference is that the monomer units which derive from subcomponent a)γ) derive from a single dicarboxylic acid, since although the mixtures of dicarboxylic acids give higher transparency of the polyamide the result is lower chemicals resistance.

In one possible embodiment of the invention, subcomponent a)α) is composed of
at least respectively 50% by weight, 60% by weight, 70% by weight, 75% by weight, 80% by weight, 85% by weight, 90% by weight or 95% by weight, of m-xylylenediamine and
not more than respectively 50% by weight, 40% by weight, 30% by weight, 25% by weight, 20% by weight, 15% by weight, 10% by weight or 5% by weight of p-xylylenediamine.

In one further possible embodiment of the invention, subcomponent a)α) is composed of
more than 50% by weight or at least respectively 60% by weight, 70% by weight, 75% by weight, 80% by weight, 85% by weight, 90% by weight or 95% by weight, of p-xylylenediamine and
less than 50% by weight or at most respectively 40% by weight, 30% by weight, 25% by weight, 20% by weight, 15% by weight, 10% by weight or 5% by weight of m-xylylenediamine.

Subcomponent a) can be composed of a mixture of two or more different polyamides, each of which has the constitution described in a).

Although the polyamide according to b) can be, for example, PA6 or PA66, higher polyamides whose average number of carbon atoms in the monomer units is at least are preferred, examples being PA88, PA610, PA612, PA614, PA810, PA812, PA814, PA1010, PA1012, PA1014, PA1212, PA11 or PA12. A further preference is that the polyamide according to b) derives from a diamine which is sterically similar to xylylenediamine, i.e. that the monomer units formed therefrom have a similar length, this being the case with hexamethylenediamine, for example. It is moreover advantageous that the polyamide according to b) derives from a dicarboxylic acid which is similar to or the same as that from which the polyamide a) derives. Substantially transparent blends can be obtained most simply in these cases.

The polyamide composition can also comprise further subcomponents, examples being:
a) nucleating agents, selected from nanoscale fillers and from basic metal salts, metal oxides or metal hydroxides; amount added of the latter is at most that which can be dissolved in the melt, with reaction with the carboxy end groups of the polyamides, in order to ensure the desired transparency;
b) conventional auxiliaries and additives in the amounts usual for polyamide moulding compositions, examples being stabilizers, UV absorbers or lubricants;
c) colourants which do not significantly affect transparency, and also
d) nucleating agents based on organic compounds, which substantially do not affect transparency.

Polycondensates based on xylylenediamines are known from the literature. The use of dodecanedioic acid as acid (examples being U.S. Pat. No. 3,803,102 and U.S. Pat. No. 4,433,136) is also included here. Polyamides whose underlying structure is MXD6 or MXD12 are used for the production of films in the packaging sector (examples being EP-A-1 172 202, U.S. Pat. No. 5,955,180, EP-A-0 941 837, WO 00/23508). These films can also be multilayer films. The use of the polyamide compositions according to the claims for the production of transparent components has not hitherto been described in the literature. The German Patent Application No. 10 2005 05 1126.0 discloses the use of the polyamide composition according to the claims for the production of composite parts, but nothing is said about its transparency.

There is no restriction on the nature of the substantially amorphous polymer which forms the basis for the moulding composition of the substrate. In principle, any known substantially amorphous polymer can be used. Examples here are polyamides, polyalkyl (meth)acrylates, polycarbonate, polyester carbonate, polyesters, polyimides, polyetherimides, polymethacrylimides, polysulphone, styrene polymers, polyolefins having cyclic units, olefin-maleimide copolymers or polymers based on vinylcyclohexane.

The enthalpy of fusion of the substantially amorphous polymer is preferably less than 12 J/g, with preference less than 8 J/g, particularly preferably less than 6 J/g, with particular preference less than 4 J/g and very particularly preferably less than 3 J/g, measured by the DSC method to ISO 11357 during the 2nd heating procedure, integrating any melting peak present.

Examples of substantially amorphous polyamides that can be used according to the invention are:
the polyamide composed of terephthalic acid and/or isophthalic acid and of the isomer mixture composed of 2,2,4- and 2,4,4-trimethylhexamethylenediamine,
the polyamide composed of isophthalic acid and 1,6-hexamethylenediamine,
the copolyamide composed of a mixture of terephthalic acid/isophthalic acid and 1,6-hexamethylenediamine, if appropriate in a mixture with 4,4′-diaminodicyclohexylmethane,
the copolyamide composed of terephthalic acid and/or isophthalic acid, 3,3′-dimethyl-4,4′-diaminodicyclohexylmethane and laurolactam or caprolactam,
the (co)polyamide composed of 1,12-dodecanedioic acid or sebacic acid, 3,3′-dimethyl-4,4′-diaminodicyclohexylmethane and, if appropriate, laurolactam or caprolactam,
the copolyamide composed of isophthalic acid, 4,4′-diaminodicyclohexylmethane and laurolactam or caprolactam,
the polyamide composed of 1,12-dodecanedioic acid and 4,4′-diaminodicyclohexylmethane (given a low proportion of trans,trans-isomer),
the copolyamide composed of terephthalic acid and/or isophthalic acid and of an alkyl-substituted bis(4-aminocyclohexyl)methane homologue, if appropriate in a mixture with hexamethylenediamine,
the copolyamide composed of bis(4-amino-3-methyl-5-ethylcyclohexyl)methane, if appropriate together with a further diamine, and isophthalic acid, if appropriate together with a further dicarboxylic acid,
the copolyamide composed of a mixture of m-xylylenediamine and a further diamine, e.g. hexamethylenediamine, and isophthalic acid, if appropriate together with a further dicarboxylic acid, e.g. terephthalic acid and/or 2,6-naphthalenedicarboxylic acid,
the copolyamide composed of a mixture of bis(4-aminocyclohexyl)methane and bis(4-amino-3-methylcyclohexyl)methane and aliphatic dicarboxylic acids having from 8 to 14 carbon atoms, and
polyamides or copolyamides composed of a mixture which comprises 1,14-tetradecanedioic acid and an aromatic, arylaliphatic or cycloaliphatic diamine.

These examples can be varied very substantially via addition of further components (e.g. caprolactam, laurolactam or diamine/dicarboxylic acid combinations) or via partial or complete replacement of starting components by other components.

The polyamides mentioned, and further suitable substantially amorphous polyamides, and suitable preparation methods, are described, inter alia, in the following patent applications: WO 02090421, EP-A-0 603 813, DE-A 37 17 928, DE-A 100 09 756, DE-A 101 22 188, DE-A 196 42 885, DE-A 197 25 617, DE-A 198 21 719, DE-C 198 41 234, EP-A-1 130 059, EP-A 1 369 447, EP-A 1 595 907, CH-B-480 381, CH-B-679 861, DE-A-22 25 938, DE-A-26 42 244, DE-A-27 43 515, DE-A-29 36 759, DE-A-27 32 928, DE-A-43 10 970, EP-A-0 053 876, EP-A-0 271 308, EP-A-0 313 436, EP-A-0 725 100 and EP-A-0 725 101.

Another suitable substrate material is polyalkyl (meth)acrylates having from 1 to 6 carbon atoms in the carbon chain of the alkyl moiety, where the methyl group is preferred as alkyl group. The melt flow rate of the polyalkyl (meth)acrylates is usually from 0.5 to 30 g/10 min, preferably from 0.8 to 15 g/10 min, measured to ISO 1133 at 230° C. using a load of 3.8 kg. Examples that may be mentioned are, inter alia, polymethyl methacrylate and polybutyl methacrylate. However, it is also possible to use copolymers of the polyalkyl (meth)acrylates. It is therefore possible to replace up to 50% by weight, preferably up to 30% by weight and particularly preferably up to 20% by weight, of the alkyl(meth)acrylate by other monomers, e.g. (meth)acrylic acid, styrene, acrylonitrile, acrylamide, or the like. Copolymers composed of methyl methacrylate and dicyclopentyl methacrylate are also suitable. The moulding composition can be rendered impact-resistant, for example via addition of a core-shell rubber conventional for moulding compositions of this type. Other thermoplastics, such as SAN (styrene/acrylonitrile copolymer) and/or polycarbonate can also be present in amounts of less than 50% by weight, preferably not more than 40% by weight, particularly preferably not more than 30% by weight and with particular preference not more than 20% by weight.

The substrate can also be composed of a moulding composition which comprises a polycarbonate as main constituent. Polycarbonates suitable according to the invention contain units which are diesters of diphenols with carbonic acid. The diphenols can by way of example be the following: hydroquinone, resorcinol, dihydroxybiphenyls, bis(hydroxyphenyl)alkanes, bis(hydroxyphenyl)cycloalkanes, bis(hydroxyphenyl)sulphides, bis(hydroxyphenyl)ethers, bis(hydroxyphenyl)ketones, bis(hydroxyphenyl)sulphones, bis(hydroxyphenyl) sulphoxides, α,α′-bis(hydroxyphenyl)diisopropylbenzenes, and also their ring-alkylated or ring-halogenated derivatives, or else α,ω-bis(hydroxyphenyl)polysiloxanes.

Examples of preferred diphenols are 4,4′-dihydroxybiphenyl, 2,2-bis(4-hydroxyphenyl)propane (bisphenol A), 1,1-bis(4-hydroxyphenyl)-3,3,5-trimethylcyclohexane, 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3-bis[2-(4-hydroxyphenyl)-2-propyl]benzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

The diphenols can be used either alone or else in a mixture with one another. The diphenols are known from the literature or can be prepared by methods known from the literature (see, for example, B. H. J. Buysch et al., Ullmann's Encyclopedia of Industrial Chemistry, VCH, New York 1991, 5th Edn., Vol. 19, p. 348).

The polycarbonates used according to the invention are prepared by known methods, for example by the interfacial process or by the melt transesterification process. Their weight-average molecular weights M_{w} (determined via gel permeation chromatography and calibration with a polystyrene standard) are from 5000 to 200 000, preferably from 10 000 to 80 000 and particularly preferably from 15 000 to 40 000.

The polycarbonate moulding composition can by way of example comprise less than 50% by weight, preferably less than 40% by weight, particularly preferably less than 30% by weight and with particular preference less than 20% by weight, based on the entire underlying polymer, of other polymers, examples being polyethylene terephthalate, polybutylene terephthalate, polyesters composed of cyclohexanedimethanol, ethylene glycol and terephthalic acid, polyesters composed of cyclohexanedimethanol and cyclohexanedicarboxylic acid, polyalkyl (meth)acrylates, SAN, styrene-(meth)acrylate copolymers, polystyrene (amorphous or syndiotactic), polyetherimides, polyimides, polysulphones, polyarylates (e.g. based on bisphenol A and isophthalic acid/terephthalic acid).

Polyester carbonates are composed of at least one diphenol, of at least one aromatic dicarboxylic acid and of carbonic acid. Diphenols suitable are the same as those for polycarbonate. Based on the sum of the fractions deriving from aromatic dicarboxylic acids and carbonic acid, the fraction deriving from aromatic dicarboxylic acids amounts to not more than 99.9 mol %, not more than 95 mol %, not more than 90 mol %, not more than 85 mol %, not more than 80 mol % or not more than 75 mol %, while their minimum proportion amounts to 0.1 mol %, 5 mol %, 10 mol %, 15 mol %, 20 mol % or 25 mol %. Examples of suitable aromatic dicarboxylic acids are orthophthalic acid, terephthalic acid, isophthalic acid, tert-butylisophthalic acid, 3,3′-diphenyldicarboxylic acid, 4,4′-diphenyl ether dicarboxylic acid, 4,4′-diphenyl sulphone dicarboxylic acid, 3,4′-benzophenonedicarboxylic acid, 2,2-bis(4-carboxyphenyl)propane and trimethyl-3-phenylindane-4,5-dicarboxylic acid. Among these, preference is given to use of terephthalic acid and/or isophthalic acid.

Suitable thermoplastic polyesters are preferably of either fully aromatic or mixed aliphatic/aromatic structure. In the first case, these are polyarylates; these derive from diphenols and from aromatic dicarboxylic acids. Suitable diphenols are the same as those for polycarbonate, while suitable dicarboxylic acids are the same as those for polyester carbonates. In the second case, the polyesters derive from one or more aromatic dicarboxylic acids and from one or more diols; examples of these are polyethylene terephthalate or copolyesters composed of terephthalic acid, 1,4-cyclohexanedimethanol and ethylene glycol.

Suitable polysulphones are generally prepared via polycondensation of a bisphenol/dihalodiaryl sulphone mixture in an aprotic solvent in the presence of a base, e.g. sodium carbonate. Examples of bisphenol that can be used are those also suitable for the preparation of polycarbonates, but in particular bisphenol A, 4,4′-dihydroxydiphenyl sulphone, 4,4′-dihydroxybiphenyl and hydroquinone, and mixtures composed of various bisphenols can also be used. In most cases, the dihalo compound is 4,4′-dichlorodiphenyl sulphone; however, it is also possible to use any other dihalo compound in which the halogen has activation by a para-positioned sulphone group. Fluorine is another suitable halogen, alongside chlorine. The expression “polysulphone” also includes the polymers usually termed “polyether sulphone” or “polyphenylene sulphone”. Suitable types are commercially available.

Polyimides are prepared in a known manner from tetracarboxylic acids or from their anhydrides, and from diamines. If the tetracarboxylic acid and/or the diamine contains an ether group, the product is a polyetherimide. The compound I is one particularly suitable tetracarboxylic acid containing ether groups; together with aromatic diamines, it gives amorphous polyetherimides which are commercially available.

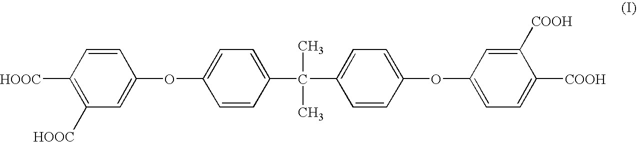

Other suitable polyimides are polymethacrylimides, sometimes also termed polyacrylimides or polyglutarimides. These are products based on polyalkyl acrylates or on polyalkyl methacrylates, in which two adjacent carboxylate groups have been reacted to give a cyclic imide. Imide formation is preferably carried out using ammonia or using primary amines, e.g. methylamine. The products and their preparation are known (Hans R. Kricheldorf, Handbook of Polymer Synthesis, Part A, Verlag Marcel Dekker Inc. New York-Basle-Hong Kong, p. 223 et seq., H. G. Elias, Makromoleküle [Macromolecules], Hüthig and Wepf Verlag Basle-Heidelberg-New York; U.S. Pat. No. 2,146,209 A; U.S. Pat. No. 4,246,374).

Examples of suitable styrene polymers are homopolystyrene or copolymers of styrene having up to 50 mol %, based on the monomer mixture, of other monomers, e.g. methyl methacrylate, maleic anhydride, acrylonitrile or maleimides. Styrene-maleimide copolymers are also, for example, available by reaction of styrene-maleic anhydride copolymers with ammonia or with primary amines, such as methylamine or aniline.

Polyolefins having cyclic units can be prepared (WO 00/20496, U.S. Pat. No. 5,635,573, EP-A-0 729 983, EP-A-0 719 803) by copolymerization of at least one cyclic or polycyclic olefin, for example norbornene or tetracyclododecene, with at least one acyclic olefin, such as ethene. This class of substance is termed COC. Another suitable class of substance, which is usually termed COP, is provided by unhydrogenated or hydrogenated products of the ring-opening metathetic polymerization of polycyclic olefins, such as norbornene, dicyclopentadiene, or substituted or Diels-Alder adducts thereof (EP-A-0 784 066, WO 01/14446, EP-A-0 313 838, U.S. Pat. No. 3,676,390, WO 96/20235).

Olefin-maleimide copolymers are known, for example, from U.S. Pat. No. 7,018,697.

Polymers based on vinylcyclohexane can be prepared (WO 94/21694, WO 00/49057, WO 01/30858; F. S. Bates et al., PCHE-Based Pentablock Copolymers: Evolution of a New Plastic, AIChE Journal Vol. 47, No. 4, pp. 762-765) either by polymerization or copolymerization of vinylcyclohexane or by catalytic hydrogenation of styrene polymers.

The moulding composition of the substrate can also comprise other familiar auxiliaries or additives, e.g. stabilizers, processing aids, flame retardants, plasticizers, antistats, isorefractive fillers or isorefractive reinforcing materials, isorefractive impact modifiers, dyes which do not significantly impair transparency, flow aids, mould-release agents or other polymers which do not significantly impair transparency. The total amount of all auxiliaries and additives amounts to not more than 50% by weight, preferably not more than 40% by weight, particularly preferably not more than 30% by weight, and with particular preference not more than 20% by weight.

The bonding of the outer layer to the substrate can take place in any known manner, for example by multicomponent injection moulding, coextrusion, in-mould coating of a film, extrusion lamination, lamination, pressing or adhesive bonding.

Multicomponent injection moulding serves for production of mouldings with layers or regions composed of different plastics or colourings. Various variants of the process are possible and known to the person skilled in the art. Two or more injection-moulding units are generally used, operating in succession into a mould. Once the first unit has filled one mould cavity, the mould cavity is enlarged for the injection-moulding procedure from the second unit, for example by displacement movements of the mould halves, rotation of mould halves or of mould parts, or core-puller movements to provide access to additional cavity regions. It is also possible to operate sequentially using a plurality of moulds on standard single-component machines, by respective placing of mouldings into the next mould and applying the following subcomponent by injection. In another possible method of operation, the first unit is used for partial filling of the mould and the melt from the second unit displaces the melt from the first unit from the core region towards the surface of the moulding, whereupon the finished component has a skin-core structure (sandwich structure). Another variant is the monosandwich process, in which the melts are conveyed by way of two separate plastifying units into a shared injection space and are spatially layered in succession. One of the subcomponents then displaces the other subcomponent towards the surface during the injection procedure.

Multilayer structures, e.g. sheets, can by way of example be produced by coextrusion. In coextrusion, a plurality of melt streams of plastics of similar type or of different type are combined with one another. The variants of the process are known to the person skilled in the art. In principle, combination of the melts can take place prior to, in or downstream of a die. Coalescence of the melts downstream of (e.g. in blow moulding) or in the die has the advantage that the melts can receive different heat treatments. In the case of “adapter dies”, the melts coalesce prior to entry into the shaping die. The multilayer structures (e.g. multilayer sheets) can be calendered where possible. An alternative is the chill-roll process. The coextrusion process can be supplemented by a subsequent blow-moulding process.

In the in-mould coating of a film, the film is placed in an injection mould, if appropriate after prior subjection to a forming process (e.g. thermoforming), and is then brought into contact with the melt of the substrate. This gives a composition component. The various variants of the process are known to the person skilled in the art. In one variant of this process, the mould is only partially filled with melt after the film has been input in place, and then the space within the mould is reduced in a controlled manner by displaceable parts, in a manner similar to that for the injection-compression moulding process.

Other processes can also be used to produce the composite material, an example being extrusion lamination. In this process, a prefabricated substrate is continuously combined with a prefabricated outer layer, and the bond here is brought about by a plastics melt which is fed at the point of contact of the first-mentioned subcomponents. A three-layer structure is obtained here. One variant consists in extruding the substrate material onto the prefabricated outer layer, or the outer layer onto a prefabricated substrate. Another possibility is provided by continuous lamination processes where the bond is achieved by introducing adhesives (solvent-based, hot-melt, etc.).

As an alternative, composites can also be produced by pressure processes, where the bond between the prefabricated materials to be joined is created by exposure to pressure and heat, e.g. in a press. This process, too, can also use adhesives, etc.

The surface can by way of example be structured by embossing. Prior structuring of the surface is also possible in the context of film extrusion, for example by specifically designed rolls. The composition part obtained can then be subjected to a forming process.

The bond between outer layer and substrate can take place by interlocking, for example by means of undercuts. However, preference is generally given to a coherent bond. For this, the materials must adhere to one another, and this is brought about by way of example via chemical linkage or by entanglement of the macromolecules.

In principle, a welding process (e.g. laser welding) can also be used for the bonding of outer layer and substrate or semi-finished film product and substrate.

Suitable combinations of materials which adhere firmly to one another are known to the person skilled in the art or can be determined by simple experimentation. In cases where it is impossible to achieve adequate adhesion, an adhesion promoter can be used, for example in the form of a multilayer film, comprising an adhesion-promoter layer on the substrate side. The nature of the adhesion promoter is not critical; however, it should preferably have sufficient transparency at the layer thickness selected.

In one embodiment, the adhesion promoter comprises a blend composed of a polymer which is identical with, or similar to, the polymer of the outer layer, and also of a polymer which is identical with, or similar to, the amorphous polymer of the substrate. “Similar” means that the relevant polymers can be mixed in the melt to give phase-stable blends, and, respectively, that layers composed of the two polymers have adequate adhesion to one another after coextrusion or in-mould coating, i.e. that the polymers are compatible with one another. Compatible polymer combinations are known to the person skilled in the art or can be determined by simple experimentation. The blend is usually prepared by mixing in the melt. Suitable mixing ratios in percent by weight are from 20:80 to 80:20, preferably from 30:70 to 70:30 and particularly preferably from 40:60 to 60:40. A compatibilizer can be used concomitantly if appropriate, an example being a branched polymer, such as a polyamine-polyamide graft copolymer (EP-A-1 065 048), a polymer having reactive groups and capable of entering into a chemical reaction at least with one of the constituents of the blend, or a block copolymer.

In another embodiment, the adhesion promoter comprises from 2 to 100% by weight, preferably from 5 to 90% by weight, particularly preferably from 10 to 80% by weight, with particular preference from 15 to 60% by weight and very particularly preferably from 20 to 40% by weight, of a copolymer which contains the following monomer units:
from 70 to 99.9% by weight of monomer units which derive from vinyl compounds selected from acrylic acid derivatives, methacrylic acid derivatives, α-olefins and vinyl aromatics and
from 0.1 to 30% by weight of monomer units which contain a functional group selected from a carboxylic anhydride group, an epoxy group and an oxazoline group.

The copolymer preferably contains the following monomer units:
1. From about 70 to about 99.9% by weight, preferably from 80 to 99.4% by weight and particularly preferably from 85 to 99% by weight, of monomer units selected from units of the following formulae:

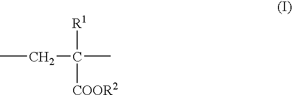

where R¹=H or CH₃ and R²=H, methyl, ethyl, propyl or butyl;

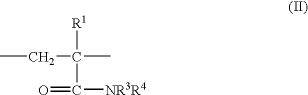

where R¹ is as above and R³ and R⁴, independently of one another, are H, methyl or ethyl;

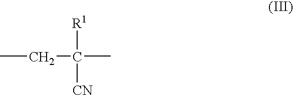

where R¹ is as above;

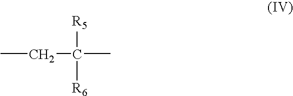

where R⁵=H or CH₃ and R⁶=H or C₆H₅;

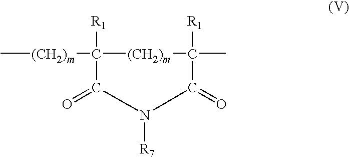

where R¹ is as above and R⁷=H, methyl, ethyl, propyl, butyl or phenyl and m=0 or 1;
2. from about 0.1 to about 30% by weight, preferably from 0.6 to 20% by weight and particularly preferably from 1 to 15% by weight of monomer units selected from units of the following formulae:

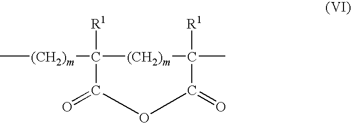

where R¹ and m are as above;

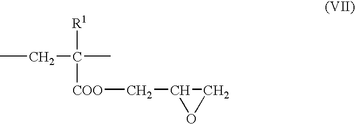

where R¹ is as above;

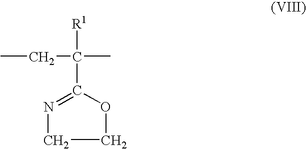

where R¹ is as above.

The limitation of chain length in the case of substituents R¹ to R⁵ and R⁷ is based on the fact that longer alkyl radicals lead to a lowered glass transition temperature and therefore to reduced heat resistance. This may be acceptable in a few cases.

The units of the formula (I) derive by way of example from acrylic acid, methacrylic acid, methyl acrylate, ethyl acrylate, n-butyl acrylate, methyl methacrylate, n-propyl methacrylate, or isobutyl methacrylate.

The units of the formula (II) derive by way of example from acrylamide, methacrylamide, N-methylacrylamide, N-methylmethacrylamide, or N,N-dimethylacrylamide.

The units of the formula (III) derive from acrylonitrile or methacrylonitrile.

The units of the formula (IV) derive from ethene, propene, styrene or α-methylstyrene; these can be replaced entirely or to some extent by other polymerizable aromatics, such as p-methylstyrene or indene, which have the same effect.

If m=0, the units of the formula (V) derive from unsubstituted or substituted maleimides, such as maleimide, N-methylmaleimide, N-ethylmaleimide, N-phenylmaleimide, or N-methylaconitimide. If m=1, they derive by reaction with ammonia or with a primary amine of two adjacent units of the formula (I) in a polymer, forming an imide.

If m=0, the units of the formula (VI) derive from unsubstituted or substituted maleic anhydrides, such as maleic anhydride or aconitic anhydride. These latter compounds can be replaced entirely or to some extent by other unsaturated acid anhydrides, e.g. itaconic anhydride, which have the same effect. If m=1, they derive by elimination of water from two adjacent units of the formula (I) in a polymer (R²=H), with ring closure.

The units of the formula (VII) derive from glycidyl acrylate or glycidyl methacrylate, and the units of the formula (VIII) derive from vinyloxazoline or isopropenyloxazoline.

Various embodiments of the copolymer are preferred, and contain the following units:
A. From 14 to 96% by weight, preferably from 20 to 85% by weight, and particularly preferably from 25 to 75% by weight, of units of the formula (I), where R² is not H;
from 0 to 75% by weight, preferably from 1 to 60% by weight, and particularly preferably from 5 to 40% by weight, of units of the formula (V), where m=1;
from 0 to 15% by weight, preferably from 0 to 10% by weight, and particularly preferably from 0.1 to 7% by weight, of units of the formula (I), where R²=H;
from 0.1 to 30% by weight, preferably from 1 to 20% by weight, and particularly preferably from 2 to 15% by weight, of units of the formula (VI), where m=1.
If units of the formula (V) are present, these copolymers are termed polyacrylimides or polymethacrylimides or sometimes also polyglutarimides. These are products which come from polyalkyl acrylates and, respectively, polyalkyl methacrylates, in which two adjacent carboxylate groups have been reacted to give a cyclic imide. The imide is preferably formed with ammonia or with primary amines, e.g. methylamine, in the presence of water, and the units of the formula (VI) and, where appropriate, units of the formula (I), where R²=H, are produced concomitantly by hydrolysis. The products are known, as also is their preparation (Hans R. Kricheldorf, Handbook of Polymer Synthesis, Part A, Verlag Marcel Dekker Inc. New York-Basle-Hong Kong, p. 223 et seq., H. G. Elias, Makromoleküle [Macromolecules], Hüthig and Wepf Verlag Basle-Heidelberg-New York; U.S. Pat. No. 2,146,209 A; U.S. Pat. No. 4,246,374). If water only is used for the reaction, the product is units of the formula (VI) and also, if appropriate, acidic units (I) by hydrolysis, without formation of imide units (V).
B. From 10 to 60% by weight, preferably from 15 to 50% by weight and particularly preferably from 20 to 40% by weight of units of the formula (IV);
from 39.9 to 80% by weight, preferably from 44.9 to 75% by weight and particularly preferably from 49.9 to 70% by weight of units of the formula (III);
from 0.1 to 30% by weight, preferably from 0.6 to 20% by weight and particularly preferably from 1 to 15% by weight of units of the formula (VI), where m=0.
Copolymers of this type are obtainable in a known manner by free-radical-initiated copolymerization of, for example, aliphatically unsaturated aromatics, unsaturated carboxylic anhydrides, and acrylonitrile or methacrylonitrile.
C. From 39.9 to 99.9% by weight, preferably from 49.9 to 99.4% by weight and particularly preferably from 59.9 to 99% by weight, of units of the formula (I);
from 0 to 60% by weight, preferably from 0.1 to 50% by weight and particularly preferably from 2 to 40% by weight of units of the formula (IV);
from 0.1 to 30% by weight, preferably from 0.6 to 20% by weight and particularly preferably from 1 to 15% by weight of units of the formula (VI), where m=0.
Copolymers of this type are obtainable in a known manner by free-radical-initiated copolymerization of acrylic acid, methacrylic acid and/or esters thereof and, if appropriate, aliphatically unsaturated aromatics or olefins and unsaturated carboxylic anhydrides.
D. From 25 to 99.8% by weight, preferably from 40 to 98.4% by weight and particularly preferably from 50 to 97% by weight of units of the formula (I);
from 0.1 to 45% by weight, preferably from 1 to 40% by weight and particularly preferably from 2 to 35% by weight of units of the formula (III);
from 0.1 to 30% by weight, preferably from 0.6 to 20% by weight and particularly preferably from 1 to 15% by weight of units of the formula (VI), where m=0.
Copolymers of this type are obtainable in a known manner by free-radical-initiated copolymerization of acrylic acid, methacrylic acid, and/or esters thereof, or acrylonitrile or methacrylonitrile and unsaturated carboxylic anhydrides.
E. From 0 to 99.9% by weight, preferably from 0.1 to 99.4% by weight, and particularly preferably from 2 to 99% by weight, of units selected from the formulae (I), where R² is not H, and (III),
from 0 to 60% by weight, preferably from 0.1 to 50% by weight, and particularly preferably from 2 to 40% by weight, of units of the formula (IV),
from 0.1 to 30% by weight, preferably from 0.6 to 20% by weight, and particularly preferably from 1 to 15% by weight, of units of the formula (VII).
F. From 0 to 99.9% by weight, preferably from 0.1 to 99.4% by weight, and particularly preferably from 2 to 99% by weight, of units selected from the formulae (I), where R² is not H, and (III),
from 0 to 60% by weight, preferably from 0.1 to 50% by weight, and particularly preferably from 2 to 40% by weight, of units of the formula (IV),
from 0.1 to 30% by weight, preferably from 0.6 to 20% by weight, and particularly preferably from 1 to 15% by weight, of units of the formula (VIII).

The copolymer can always contain other additional monomer units, such as those which derive from maleic diesters, from fumaric diesters, from itaconic esters or from vinyl acetate, as long as the desired adhesion-promoting effect is not substantially impaired thereby.

In one embodiment, the adhesion promoter can be composed entirely of the copolymer; in a variant of this, the copolymer comprises an impact modifier, e.g. an acrylate rubber.

In another embodiment, the adhesion promoter comprises from 2 to 99.9% by weight, preferably from 5 to 90% by weight, particularly preferably from 10 to 80% by weight, with particular preference from 15 to 60% by weight, and very particularly preferably from 20 to 40% by weight, of the copolymer, and from 0.1 to 98% by weight, preferably from 10 to 95% by weight, particularly preferably from 20 to 90% by weight, with particular preference from 40 to 85% by weight, and very particularly preferably from 60 to 80% by weight, of a polymer selected from the group of the polyamide of the outer layer, the polymer of the substrate, polyamide similar to the polyamide of the outer layer, polymer similar to the polymer of the substrate, and mixtures thereof.

The adhesion promoter can comprise the usual auxiliaries and additives, e.g. flame retardants, stabilizers, plasticizers, processing aids, dyes or the like. The amount fed of the agents mentioned is to be such as not to give any serious impairment of the desired properties.

In the case of combinations of materials which are difficult to bond, it can be advisable to use two successive mutually compatible adhesion-promoter layers, one of which couples to the polyamide layer and the other of which couples to the substrate.

Alongside the layer present according to the invention which is composed of a polyamide moulding composition and, if appropriate, an adhesion-promoter layer, other layers can be present in the film, as a function of the application, examples being on the substrate side, a supportive layer composed of a moulding composition whose polymer constitution is preferably substantially the same as that of the substrate, a colour layer and/or a further polyamide layer, for example as backing layer.

The colour layer is preferably composed, as in the prior art, of a coloured thermoplastics layer. The thermoplastics layer can be identical with the outer layer. In another embodiment, the colour layer can be adjacent to the outer layer, towards the inside. Organic dyes are generally used as colourants.

A backing layer is a layer which gives the film greater strength by virtue of its thickness.

A peelable protective film, which provides protection during transport or installation and is peeled off after production of the composite part, can also be applied by lamination to the finished multilayer film.

In one preferred embodiment, the thickness of the film is from 0.02 to 1.2 mm, particularly preferably from 0.05 to 1 mm, very particularly preferably from 0.08 to 0.8 mm and with particular preference from 0.15 to 0.6 mm. In one preferred embodiment here, the thickness of the adhesion-promoter layer is from 0.01 to 0.5 mm, particularly preferably from 0.02 to 0.4 mm, very particularly preferably from 0.04 to 0.3 mm and with particular preference from 0.05 to 0.2 mm. The film is produced by means of known methods, for example by extrusion, or in the case of multilayer systems by coextrusion or lamination. It can then, if appropriate, be subjected to a forming process.

If the component is produced by multicomponent injection moulding, the thickness of the outer layer is generally from 0.1 to 10 mm, preferably from 0.2 to 7 mm and particularly preferably from 0.5 to 5 mm. Layer thicknesses below 0.1 mm are also possible under specific processing conditions. Low thicknesses generally lead to better transparency of the component. In the case of production by coextrusion, the thickness of the outer layer is generally from 0.02 to 1.2 mm, preferably from 0.05 to 0.8 mm, particularly preferably from 0.08 to 0.6 mm and with particular preference from 0.12 to 0.5 mm.

The substrate can have any desired thickness. Its thickness is generally in the range from 0.5 to 100 mm, preferably in the range from 0.8 to 80 mm, particularly preferably in the range from 1 to 60 mm, with particular preference in the range from 1.2 to 40 mm and very particularly preferably in the range from 1.4 to 30 mm. Further preference is given to upper thickness limits of 25 mm, 20 mm, 15 mm, 10 mm, 6 mm, 5 mm and 4 mm. The thickness is to be selected in such a way that the component has the stiffness required. The inventive component is not a film; unlike a film, it is dimensionally stable.

In one preferred embodiment, the inventive component is used as optical component. Examples of these are diffuser sheets, headlight lenses, tail-light lenses, any other type of lens, prisms, spectacle lenses, displays, decorative components for a display, backlight switches, panels of any type, or mobile-telephone casings.

### 1. Preparation of PA MXD10

The following starting materials were charged to a 100 l polycondensation reactor:
11.751 kg of m-xylylenediamine
17.449 kg of 1,10-decanedioic acid (sebacic acid)
18.326 kg of deionized water
3.281 g of a 50% strength aqueous solution of hypophosphorous acid.

The starting materials were melted under nitrogen with stirring, and heated to about 180° C. in a sealed autoclave, the resultant internal pressure being about 20 bar. This internal pressure was maintained for 2 hours, and then the melt was heated further to 280° C., with continuous depressurization to atmospheric pressure. Nitrogen was then passed over the melt while it was maintained at 280° C. for about 1 hour, until the desired torque was indicated. The melt was then discharged by means of a gear pump and strand-pelletized. The pellets were dried for 16 hours at 80° C. in the vacuum provided by a water pump.

Yield: 21.3 kg

The product had the following properties:

Crystallite melting point Tₘ: 188° C.
Relative solution viscosity ηᵣₑₗ: 1.65

### 2. Preparation of PA MXD12

The following starting materials were charged to a 100 l polycondensation reactor:
11.441 kg of m-xylylenediamine
19.347 kg of 1,12-dodecanedioic acid
19.57 kg of deionized water
3.17 g of a 50% strength aqueous solution of hypophosphorous acid.

The procedure was as above.

Yield: 24 kg

The product had the following properties:

Crystallite melting point Tₘ: 183° C.
Relative solution viscosity ηᵣₑₗ: 1.58

### 3. Preparation of PA MXD13

The following starting materials were charged to a 100 l polycondensation reactor:
11.761 kg of m-xylylenediamine
21.100 kg of 1,13-tridecanedioic acid (brassylic acid)
21.76 kg of deionized water
3.373 g of a 50% strength aqueous solution of hypophosphorous acid

The procedure was as above.

Yield: 24.1 kg

The product had the following properties:

Crystallite melting point Tₘ: 167° C.
Relative solution viscosity ηᵣₑₗ: 1.57

### 4. Preparation of PA MXD14

The following starting materials were charged to a 100 l polycondensation reactor:
12.939 kg of m-xylylenediamine
24.544 kg of 1,14-tetradecanedioic acid
11.11 kg of deionized water
3.88 g of a 50% strength aqueous solution of hypophosphorous acid.

The procedure was as above.

Yield: 31.2 kg

The product had the following properties:

Crystallite melting point Tₘ: 183° C.
Relative solution viscosity ηᵣₑₗ: 1.60

### 5. Preparation of PA MXD18

The following starting materials were charged to a 100 l polycondensation reactor:
10.880 kg of m-xylylenediamine
25.120 kg of 1,18-octadecanedioic acid
9.08 kg of deionized water
4.14 g of a 50% strength aqueous solution of hypophosphorous acid.

The procedure was as above.

Yield: 29.5 kg

The product had the following properties:

Crystallite melting point Tₘ: 173° C.
Relative solution viscosity ηᵣₑₗ: 1.56

### 6. Preparation of Co-PA MXD12/PXD12

The following starting materials were charged to a 100 l polycondensation reactor:
8.174 kg of m-xylylenediamine
3.407 kg of p-xylylenediamine
19.577 kg of 1,12-dodecanedioic acid
19.86 kg of deionized water
3.230 g of a 50% strength aqueous solution of hypophosphorous acid.

The procedure was as above.

Yield: 24.9 kg

The product had the following properties:

Crystallite melting point Tₘ: 197° C.
Relative solution viscosity ηᵣₑₗ: 1.55

### Other Materials Used:

### Adhesion

promoter (AP): a copolymer of the following constitution:
   a) 57% by weight of monomer units of the formula

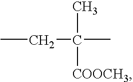

b) 30% by weight of monomer units of the formula

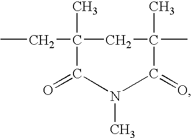

c) 3% by weight of monomer units of the formula

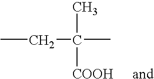

d) 10% by weight of monomer units of the formula

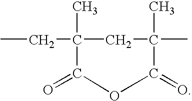

The copolymer, a polymethacrylimide, can be prepared via reaction of a melt of polymethylmethacrylate (PMMA) with an aqueous methylamine solution, for example in an extruder.
PMMA: PLEXIGLAS® 7N (Röhm GmbH)
Polycarbonate (PC): LEXAN® 101 R (GE Plastics)
Amorphous polyamides: PA type A: TROGAMID® CX9704, a polyamide composed of 1,12-dodecanedioic acid and 4,4′-diaminodicyclohexylmethane (PA PACM12);
   PA type B: GRILAMID® TR90, a polyamide composed of 1,12-dodecanedioic acid and 3,3′-dimethyl-4,4′-diaminodicyclohexylmethane;
   PA type C: TROGAMID® T5000, a polyamide composed of terephthalic acid and 2,2,4-/2,4,4-trimethylhexamethylenediamine

### Processing

### 1. Compounding

The polyamides prepared, and the polyamides used in the comparative examples, were, if appropriate together with the polyamides stated in the tables, compounded with 0.75% by weight of a stabilizer mixture and 0.05% by weight of a nucleating agent (in each case based on the polyamide) in a Werner+Pfleiderer ZSK 30 twinscrew kneader with barrel temperature of 240° C. (PA MXD6: 280° C.) at 150 rpm with throughput of 20 kg/hour.

### 2. Film Extrusion

The multilayer films were produced on a Collin plant with take-off speed of 2.0 m/min. The individual extruded layers were combined and passed through a calender. The width of the films was 24 cm.

### 3. In-Mould Coating

The in-mould coating process took place on an Engel 650/200 machine with mould temperature of 80° C. and melt temperature of 310° C. and, respectively, 260° C. (PMMA). The film here was cut to size to 100 mm×150 mm format and placed in a mould (sheet: 105 mm×150 mm×from 0.8 to 10 mm). The thickness of the in-mould-coated sheet, inclusive of film, was 3 mm. Table 1 collates a characteristic selection of the inventive composite parts produced.

For comparative measurements, analogous sheets were produced correspondingly from the substrate materials, but without film.

In all of the examples, firm adhesion at the layer boundaries was found when attempts were made to separate the composites mechanically. In all cases, the result was cohesive failure of the film layers, rather than separation.

The transparency of the composite parts was not discernibly impaired by the thin film.

TABLE 1
Inventive composites (in-mould-coated sheets; total thickness 3 mm)

| | Inventive | Inventive | Inventive | Inventive | Inventive |
|---|---|---|---|---|---|
| | Example 1 | Example 2 | Example 3 | Example 4 | Example 5 |
| Outer layer | PA | PA | PA | PA | PA |
| (50 μm) | MXD10 | MXD12 | MXD12/ | MXD13 | MXD14 |
| | | | PA612 | | |
| | | | 70:30^{a)} | | |
| Adhesion- | + | + | + | + | + |
| promoter | | | | | |
| layers | | | | | |
| (200 μm) | | | | | |
| Substrate | PMMA | PC | PA type A | PA type B | PA type C |

| | Inventive | Inventive | Inventive |
|---|---|---|---|
| | Example 6 | Example 7 | Example 8 |
| Outer layer (50 μm) | PA MXD14/PA1010 | PA MXD18 | PA MXD12/ |
| | 70:30^{b)} | | PXD12 |
| Adhesion-promoter | + | + | + |
| layers (200 μm) | | | |
| Substrate | PA type C | PC | PMMA |

^{a)}70 parts by weight of PA MXD12, 30 parts by weight of VESTAMID ® D16
^{b)}70 parts by weight of PA MXD14, 30 parts by weight of PA1010

### Chemicals Resistance

Chemicals resistance was determined by exposing sheets of the appropriate materials to full contact at 23° C. for 24 hours in a stand, in a glass beaker, and then assessing the surface visually. Table 2 gives the results.

TABLE 2
Chemicals resistance

| | | | | Iso- | Iso- |
|---|---|---|---|---|---|
| | Methanol | Ethanol | Acetone | propanol | octane |
| PMMA | Surface | Surface | Dissolved | No | Slight |
| | haze | cracks | completely | alteration | surface |
| | | | | | attack |
| PA | Marked | Marked | No | Marked | No |
| type C | softening; | softening; | alteration | surface | alteration |
| | partial | partial | | attack | |
| | dissolution | dissolution | | | |
| PA | No | No | No | No | No |
| MXD12 | alteration | alteration | alteration | alteration | alteration |

### Wash-Brush Resistance

In-mould-coated multilayer films were tested for wash-brush resistance by the Amtec-Kistler method, DIN 55668:2002-08, gloss being measured here to DIN 67 530 before and after the test. For reasons associated with the technology of the test, the films comprised a colour layer composed of PA12, black-coloured using carbon black. Table 3 shows the results. It is seen that markedly less damage occurs with the inventive composite parts.

TABLE 3
Wash-brush test on in-mould-coated multilayer films

| | Comparative | Comparative | Inventive | Inventive | Inventive | Inventive |
|---|---|---|---|---|---|---|
| | Example 1 | Example 2 | Example 8 | Example 9 | Example 10 | Example 11 |
| Outer layer | PA12 | PA PACM12^{a)} | PA MXD12 | PA MXD12/PA612 | PA MXD12/PA612 | PA MXD14 |
| (50 μm) | | | | 90:10 | 70:30 | |
| Colour layer | PA12 black | PA12 black | PA12 black | PA12 black | PA12 black | PA12 black |
| (200 μm) | | | | | | |
| Adhesion | + | + | + | + | + | + |
| promoter | | | | | | |
| (200 μm) | | | | | | |
| Substrate | PC | PC | PC | PC | PC | PC |
| Before: | 80.6 | 77.2 | 90.9 | 93.7 | 90.1 | 91.6 |
| 20° gloss | | | | | | |
| [gloss units] | | | | | | |
| After: | 11.2 | 8.5 | 43.3 | 38.0 | 35.4 | 25.7 |
| 20° gloss | | | | | | |
| [gloss units] | | | | | | |
| Residual gloss | 13.9 | 11.0 | 47.6 | 40.6 | 39.3 | 28.1 |
| [%] | | | | | | |

| | Inventive | Inventive | Inventive | Inventive | Inventive |
|---|---|---|---|---|---|
| | Example 12 | Example 13 | Example 14 | Example 15 | Example 16 |
| Outer layer | PA MXD10 | PA MXD13 | PA MXD18 | Co-PA MXD12/PXD12 | PA MXD14/PA1010 |
| (50 μm) | | | | | 70:30 |
| Colour layer | PA12 black | PA12 black | PA12 black | PA12 black | PA12 black |
| (200 μm) | | | | | |
| Adhesion | + | + | + | + | + |
| promoter | | | | | |
| (200 μm) | | | | | |
| Substrate | PC | PC | PC | PC | PC |
| Before: | 92.6 | 90.9 | 89.1 | 92.2 | 88.8 |
| 20° gloss | | | | | |
| [gloss units] | | | | | |
| After: | 46.3 | 34.8 | 22.6 | 41.3 | 25.4 |
| 20° gloss | | | | | |
| [gloss units] | | | | | |
| Residual gloss | 50.0 | 38.3 | 25.4 | 44.8 | 28.6 |
| [%] | | | | | |

^{a)}TROGAMID ® CX7323, a semicrystalline PA PACM12 whose trans/transdiamine content is about 50%

### Measurement of Scratch Resistance

Using an in-house Degussa method, the surface gloss was determined on in-mould-coated multilayer films before and after a scratch test. An abrasion tester was used here in compliance with Renault V. I. specification 31.03.406/A, 94-06 issue. First, gloss was measured to DIN 67530 at various sites on the test specimen. The test specimen was then installed horizontally into the holder provided for this purpose. The two projections on the underside of the lever arms were covered with a sieve textile composed of polyamide (mesh width 25 μm), wetted with 0.1% strength Persil solution. The lever arms with the friction projections were then swung around so as to bring the projections into contact with the test specimens, and each was provided with an additional weight of 3 kg. The test specimen was then moved to and fro, using 80 cycles, with the projections scratching the surface. Gloss was again measured at the scratched sites. Table 4 shows the results. It is seen that the inventive composite parts have substantially higher scratch resistance when compared with a PA12 surface or PA PACM12 surface.

TABLE 4
Scratch resistance on in-mould-coated multilayer films

| | Comparative | Comparative | Inventive | Inventive | Inventive |
|---|---|---|---|---|---|
| | Example 3 | Example 4 | Example 17 | Example 18 | Example 19 |
| Outer layer | PA12 | PA PACM12^{a)} | PA MXD12/PA612 | PA MXD12/PA612 | PA MXD14/PA1010 |
| (50 μm) | | | 90:10 | 70:30 | 70:30 |
| Colour layer | PA12 black | PA12 black | PA12 black | PA12 black | PA12 black |
| (200 μm) | | | | | |
| Adhesion | + | + | + | + | + |
| promoter | | | | | |
| (200 μm) | | | | | |
| Substrate | PC | PC | PC | PC | PC |
| Before: | 81.8 | 78.1 | 92.9 | 89.6 | 88.3 |
| 20° gloss | | | | | |
| [gloss units] | | | | | |
| After: | 2.4 | 15.2 | 64.7 | 54.1 | 40.1 |
| 20° gloss | | | | | |
| [gloss units] | | | | | |
| Residual gloss | 2.9 | 19.5 | 69.6 | 60.4 | 45.4 |
| [%] | | | | | |

^{a)}TROGAMID ® CX7323

1. A transparent component, which comprises the following subcomponents:
I. an outer layer composed of a polyamide moulding composition, which comprises the following constituents:
a) from 50 to 100 parts by weight of polyamide, which can be prepared from the following monomers:
α) from 70 to 100 mol % of diamine, selected from m-xylylenediamine, p-xylylenediamine and mixtures thereof,
β) from 0 to 30 mol % of other diamines having from 6 to 14 carbon atoms,
where the mol % data here are based on the entirety of diamine, and also
γ) from 70 to 100 mol % of aliphatic dicarboxylic acids having from 10 to 18 carbon atoms and
δ) from 0 to 30 mol % of other dicarboxylic acids having from 6 to 9 carbon atoms,
where the mol % data here are based on the entirety of dicarboxylic acid; and
b) from 0 to 50 parts by weight of another polyamide,
where the parts by weight of a) and b) give a total of 100, and
II. a substrate composed of a moulding composition based on a substantially amorphous polymer,
where
a) the outer layer, any adhesion-promoter layer present, and also any further layers present comprise no particulate additives which discernibly reduce transparency and
b) the substrate has, within the visible spectrum from 380 to 800 nm, a maximum of at least 30% in the transmittance curve, determined to ASTM D1003 on injection-moulded plaques, at a layer thickness of 1 mm.

2. The component according to claim 1,
wherein
component I.a)α) is composed of at least 50% by weight of m-xylylenediamine and not more than 50% by weight of p-xylylenediamine.

3. The component according to claim 1,
wherein
component I.a)α) is composed of more than 50% by weight of p-xylylenediamine and less than 50% by weight of m-xylylenediamine.

4. The component according to claim 1,
wherein
the substrate is a moulding composition selected from the group consisting of a substantially amorphous polyamide, a polyalkyl (meth)acrylate, a polycarbonate, a polyester carbonate, a polyester, a polyimide, a polyetherimide, a polymethacrylimide, a polysulphone, a styrene polymer, a polyolefin having cyclic units, an olefin-maleimide copolymer and a polymer based on vinylcyclohexane.

5. The component according to claim 1,
wherein
it has been produced by multicomponent injection moulding, coextrusion, in-mould coating of a film, extrusion lamination, lamination, pressing or adhesive bonding.

6. The component according to claim 1,
wherein
it comprises an adhesion promoter between the outer layer and the substrate.

7. The component according to claim 5,
wherein
it has been produced by in-mould coating of a film which comprises, alongside the outer layer, a colour layer, a polyamide layer as backing layer and/or, on the substrate side, a supportive layer.

8. The component according to claim 1 for optical applications.

9. The component according to claim 8,
wherein
it is a diffuser sheet, headlight lens, tail-light lens, any other type of lens, a prism, a spectacle lens, a display, a decorative component for a display, a backlight switch, a panel of any type, or a mobile-telephone casing.
